(19) United States
(12) Patent Application Publication
(10) Pub. No.: US 2004/0134847 A1
(43) Pub. Date: Jul. 15, 2004

(54) Water activating apparatus

(76) Inventor: Jen-Wei Lin, Taipei (TW)

Correspondence Address: CHARLES E. BAXLEY, ESQ., 90 JOHN STREET, THIRD FLOOR, NEW YORK, NY, 10038, US

(21) Appl. No.: 10/744,826

(22) Filed: Dec. 23, 2003

(30) Foreign Application Priority Data
Dec. 24, 2002 (TW) 091137227

(51) Int. Cl. C02F 1/48

(52) U.S. Cl. 210/202; 210/223

(57) ABSTRACT

A water activating apparatus includes (a) a plurality of floatable fibrous filter balls, an atomizer, a plurality of bio-chemical ceramic wave energy tubes, a receiving barrel, and a magnetizer, (b) a water softening device, (c) an ultraviolet sterilizing lamp, a porous bio-chemical ceramic wave energy plate, a plurality of magnetized bodies, an multi-layer stainless steel filter net, and a filter barrel, (d) a faucet, (e) a sprayer, (f) a sprayer switch mounted between the faucet and the sprayer, (g) a reverse washing switch, (h) a water flow monitor, (i) a gas/water mixer, a magnet-actuating reciprocating high pressure air pump, and a super-oxygen generating barrel, and (j) a transfer device. Thus, the water is activated efficiently, thereby enhancing the water quality contained in the receiving barrel.

### BACKGROUND OF THE INVENTION

1. Field of the Invention

The present invention relates to a water activating apparatus, and more particularly to a water activating apparatus having a strongly sterilizing effect and a super-oxygen content by using special floatable fibrous filter balls having high frequency bio-chemical wave energy and magnetizing effect.

2. Description of the Related Art

A conventional household water filter is used to filter and purify the water to enhance the water quality so that the user can drink the filtered water safely. However, the conventional water filter is constructed by a single device which only provides a single water filtering or purifying function and cannot integrate all of the devices into an integrated water processing system, thereby limiting the versatility of the conventional water filter.

### SUMMARY OF THE INVENTION

The primary objective of the present invention is to provide a water activating apparatus having a strongly sterilizing effect and a super-oxygen content by using special floatable fibrous filter balls having high frequency bio-chemical wave energy and magnetizing effect.

Another objective of the present invention is to provide a water activating apparatus, wherein the water is activated exactly and efficiently, thereby enhancing the water quality contained in the receiving barrel.

In accordance with the present invention, there is provided a water activating apparatus, comprising:

(a) a plurality of floatable fibrous filter balls, an atomizer, a plurality of bio-chemical ceramic wave energy tubes, a receiving barrel, and a magnetizer;

(b) a water softening device;

(c) an ultraviolet sterilizing lamp, a porous bio-chemical ceramic wave energy plate, a plurality of magnetized bodies, an multi-layer stainless steel filter net, and a filter barrel;

(d) a faucet;

(e) a sprayer;

(f) a sprayer switch mounted between the faucet and the sprayer;

(g) a reverse washing switch;

(h) a water flow monitor;

(i) a gas/water mixer, a magnet-actuating reciprocating high pressure air pump, and a super-oxygen generating barrel; and

(j) a transfer device.

Further benefits and advantages of the present invention will become apparent after a careful reading of the detailed description with appropriate reference to the accompanying drawings.

### BRIEF DESCRIPTION OF THE DRAWINGS

FIG. 1 is a side plan cross-sectional view of a magnetizer of a water activating apparatus in accordance with the preferred embodiment of the present invention;

FIG. 2 is a top plan view of the magnetizer as shown in FIG. 1;

FIG. 3 is a another plan view of the magnetizer as shown in FIG. 1;

FIG. 4 is a top plan view of the magnetizer as shown in FIG. 3;

FIG. 5 is a plan cross-sectional view of a receiving barrel of the water activating apparatus in accordance with the preferred embodiment of the present invention;

FIG. 6 is a schematic operational view of the water activating apparatus as shown in FIG. 5, wherein the water is being processed;

FIG. 7 is a schematic operational view of the water activating apparatus as shown in FIG. 6, wherein the reverse washing is performed;

FIG. 8 is a schematic operational view of the water activating apparatus as shown in FIG. 7, wherein the reverse washing is accomplished;

FIG. 9 is a schematic operational view of the water activating apparatus as shown in FIG. 8, wherein the dirty water is drained;

FIG. 10 is a schematic operational view of the water activating apparatus as shown in FIG. 9;

FIG. 11 is a side plan cross-sectional view of an atomizer in accordance with the preferred embodiment of the present invention;

FIG. 12 is a top plan view of the atomizer as shown in FIG. 11;

FIG. 13 is a perspective view of a ball in accordance with the preferred embodiment of the present invention;

FIG. 13A is a top plan view of the ball as shown in FIG. 13;

FIG. 13B is a front plan view of the ball as shown in FIG. 13;

FIG. 14 is a perspective view of a block in accordance with the preferred embodiment of the present invention;

FIG. 14A is a top plan view of the block as shown in FIG. 14;

FIG. 14B is a front plan view of the block as shown in FIG. 14;

FIG. 15 is a plan view of a cursor-plug type water flow regulator in accordance with the preferred embodiment of the present invention;

FIG. 16 is a plan view of a dual-piece cross type water flow regulator in accordance with the preferred embodiment of the present invention;

FIG. 17 is a plan view of a dual-layer porous type water mixer in accordance with the preferred embodiment of the present invention;

FIG. 18 is a plan view of a dual-layer triangular cone type water mixer in accordance with the preferred embodiment of the present invention;

FIG. 18A is a plan cross-sectional view of the dual-layer triangular cone type water mixer as shown in FIG. 18;

FIG. 19 is a plan cross-sectional view of a receiving barrel of the water activating apparatus in accordance with the preferred embodiment of the present invention;

FIG. 20 is a schematic operational view of FIG. 19, wherein the reverse washing is performed;

FIG. 21 is a schematic side plan view of FIG. 19;

FIG. 22 is a perspective view of a filter net in accordance with the preferred embodiment of the present invention;

FIG. 23 is a plan view of a sterilizing lamp in accordance with the preferred embodiment of the present invention;

FIG. 24 is a partially assembly view of the sterilizing lamp as shown in FIG. 23;

FIG. 25 is a perspective view of the sterilizing lamp as shown in FIG. 23;

FIG. 26 is a plan view of a faucet in accordance with the preferred embodiment of the present invention;

FIG. 27 is a top plan cross-sectional view of the faucet as shown in FIG. 26;

FIG. 28 is a schematic operational view of the faucet as shown in FIG. 27;

FIG. 29 is a plan view of a first sprayer in accordance with the preferred embodiment of the present invention;

FIG. 30 is a schematic operational view of the sprayer as shown in FIG. 29;

FIG. 30A is a schematic view of the sprayer as shown in FIG. 30;

FIG. 30B is a schematic view of the sprayer as shown in FIG. 30;

FIG. 30C is a schematic view of the sprayer as shown in FIG. 30;

FIG. 30D is a schematic view of the sprayer as shown in FIG. 30;

FIG. 31 is a plan view of a second sprayer in accordance with the preferred embodiment of the present invention;

FIG. 32 is a schematic operational view of the sprayer as shown in FIG. 31;

FIG. 33 is a plan view of a movable plug in accordance with the preferred embodiment of the present invention;

FIG. 34 is a plan view of a sprayer switch in accordance with the preferred embodiment of the present invention;

FIG. 35 is a schematic operational view of the sprayer switch as shown in FIG. 31;

FIG. 36 is a plan view of a water flow monitor in accordance with the preferred embodiment of the present invention, wherein the water is flowing;

FIG. 37 is a schematic operational view of the water flow monitor as shown in FIG. 36, wherein the water flow stops;

FIG. 38 is a plan view of a gas/water mixer in accordance with the preferred embodiment of the present invention, wherein the water is flowing;

FIG. 39 is a perspective view of a net in accordance with the preferred embodiment of the present invention, wherein the water is flowing;

FIG. 40 is a plan view of an air pump in accordance with the preferred embodiment of the present invention;

FIG. 41 is a schematic operational view of the air pump as shown in FIG. 40;

FIG. 42 is a plan view of a generating barrel in accordance with the preferred embodiment of the present invention;

FIG. 43 is a schematic operational view of the generating barrel as shown in FIG. 40;

FIG. 44 is a schematic operational view of the generating barrel as shown in FIG. 43;

FIG. 45 is a schematic operational view of the generating barrel as shown in FIG. 44;

FIG. 46 is a plan view of a transfer device in accordance with the preferred embodiment of the present invention; and

FIG. 47 is a side plan view of the transfer device as shown in FIG. 46.

### DETAILED DESCRIPTION OF THE INVENTION

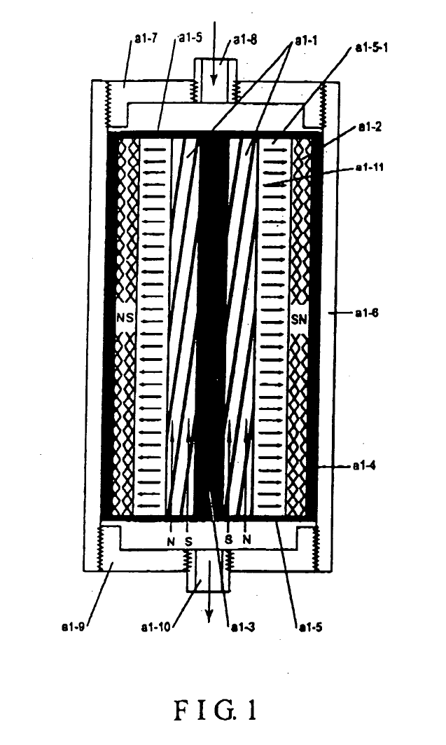

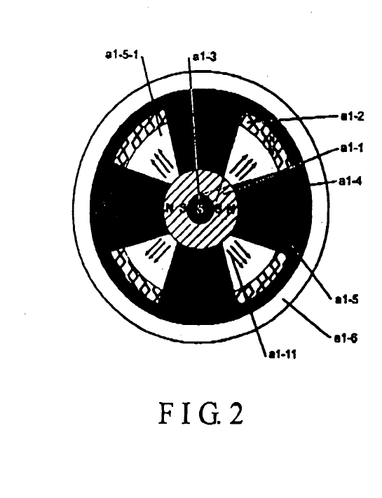

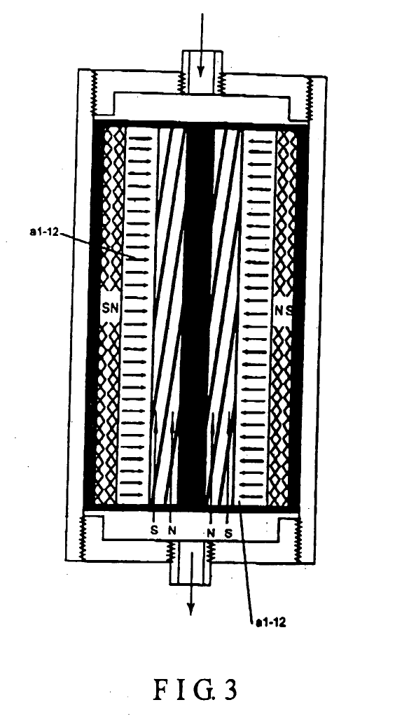

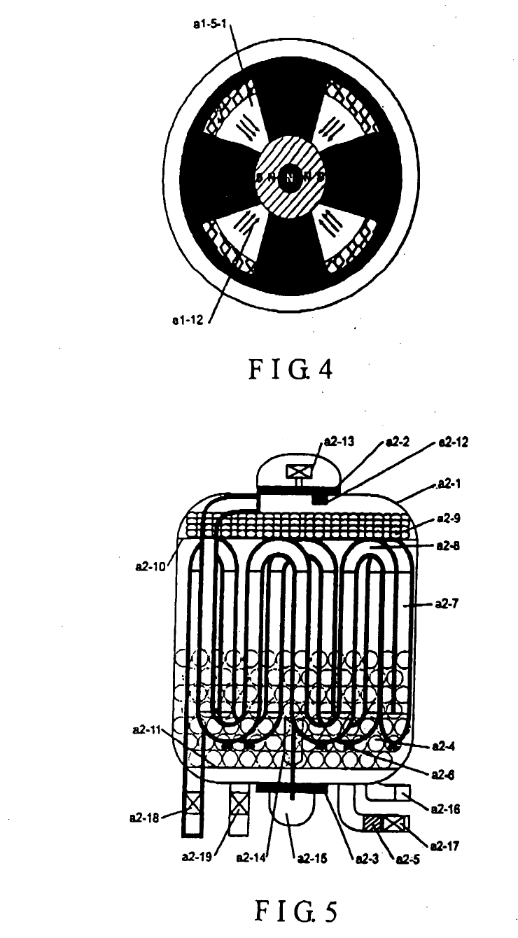

Referring to the drawings and initially to FIGS. 1-4, a water activating apparatus in accordance with the preferred embodiment of the present invention comprises a dual-tube liquid magnetizer including a magnetic inner tube a1-1, a magnetic outer tube a1-2, a magnetic conducting bar a1-3 mounted in a center of the inner tube a1-1, a magnetic conducting tube a1-4 mounted on an outer wall the outer tube a1-2, two magnetic conducting end plates a1-5 each having a water conduit a1-5 -1, an outer pipe a1-6, an upper coupler a1-7, a water inlet a1-8, a lower coupler a1-9, a water outlet a1-10, and multiple magnetic lines a1-11 and a1-12. The magnetic inner tube a1-1 has an inner wall having a N pole and an outer wall having a S pole, and the magnetic outer tube a1-2 has an inner wall having a N pole and an outer wall having a S pole. Alternatively, the magnetic inner tube a1-1 has an inner wall having a S pole and an outer wall having a N pole, and the magnetic outer tube a 1-2 has an inner wall having a S pole and an outer wall having a N pole.

The dual-tube liquid magnetizer is made of isotropic or anisotropic magnetic material, such as neodymium-iron-boron alloy, having strong magnetism, and having magnetic directions directed toward the magnetic lines a1-11 and a1-12. The water enters the water inlet a1-8 and flows through the water conduit a1-5-1 of the magnetic conducting end plate a1-5 into the magnetized zones of the magnetizer, thereby obtaining the optimum magnetizing effect. Then, the water flows outward from the water outlet a1-10. The magnetic conducting bar a1-3, the magnetic conducting end plate a1-5 and the magnetic conducting tube a1-4 are combined, thereby obtaining the minimum magnetic loss.

Referring to FIGS. 5-10, the water activating apparatus further comprises a receiving barrel a2-1 having an upper end plate a2-2, a lower end plate a2-3, an upper net plate a2-10 and a lower net plate a2-11, a plurality of floatable fibrous filter balls a2-4 mounted in the receiving barrel a2-1, a liquid magnetizing ball a2-5, a plurality of energy tubes a2-7 mounted in the receiving barrel a2-1, a plurality of multi-directional magnetized bodies a2-9 mounted in the receiving barrel a2-1, an atomizer a2-12 mounted in the receiving barrel a2-1, a check valve a2-13 mounted on the receiving barrel a2-1 to introduce the air into the receiving barrel when the sludge is drained outward, a reverse washing fan a2-14 mounted in the receiving barrel a2-1, a reverse washing motor a2-15 mounted on the receiving barrel a2-1 and connected to the reverse washing fan a2-14 to perform a reverse washing process on the floatable fibrous filter balls a2-4, and a constant pressure switch a2-16, a water inlet magnet valve a2-17, a water outlet magnet valve a2-18, and a drain magnet valve a2- 19 each mounted on the receiving barrel a2-1 respectively.

Each of the floatable fibrous filter balls a2-4 is made of floating material, such as polyester, nylon, P.V.C., PP or PE or the like, having specific gravity of about 1. The floating material is made into a film which has a surface formed with multiple pores having a diameter of at least 1 μ by a high frequency corona. Then, the film is then divided into multiple flat lines which are woven into the floatable fibrous filter ball a2-4.

Each of the energy tubes a2-7 is made of a porous bio-chemical ceramic material having a great wave energy. The ceramic material is pressed and extruded at high pressure and temperature into a tubular shape to form the energy tube a2-7. The energy tubes a2-7 are connected by a plurality of U-shaped connectors a2-8 and supported by a plurality of support racks a2-6.

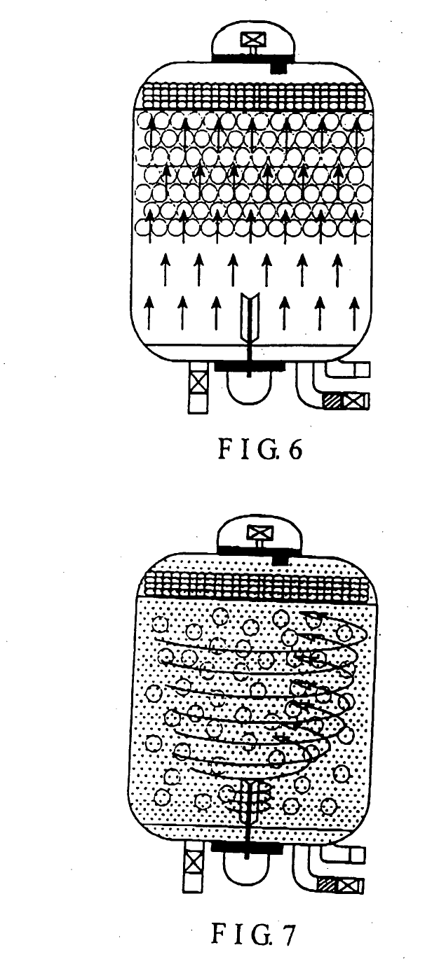

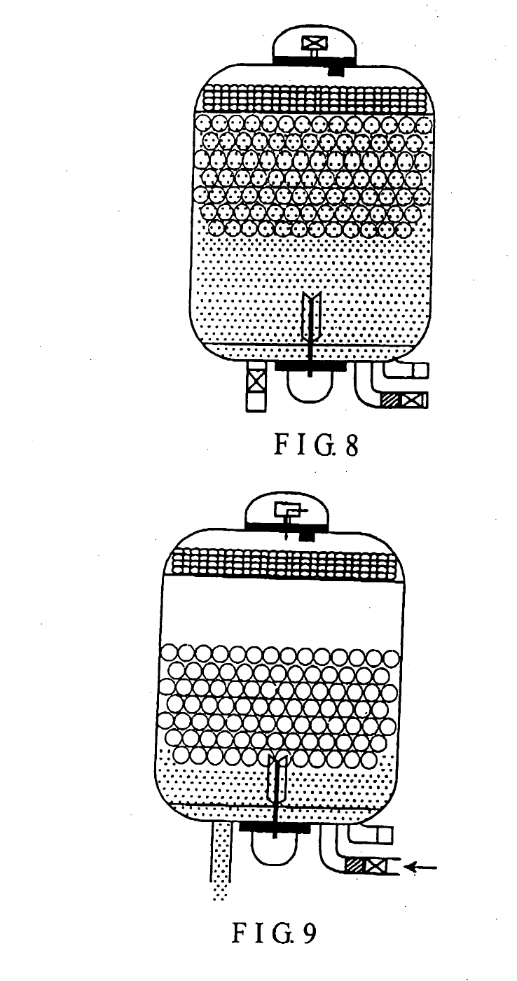

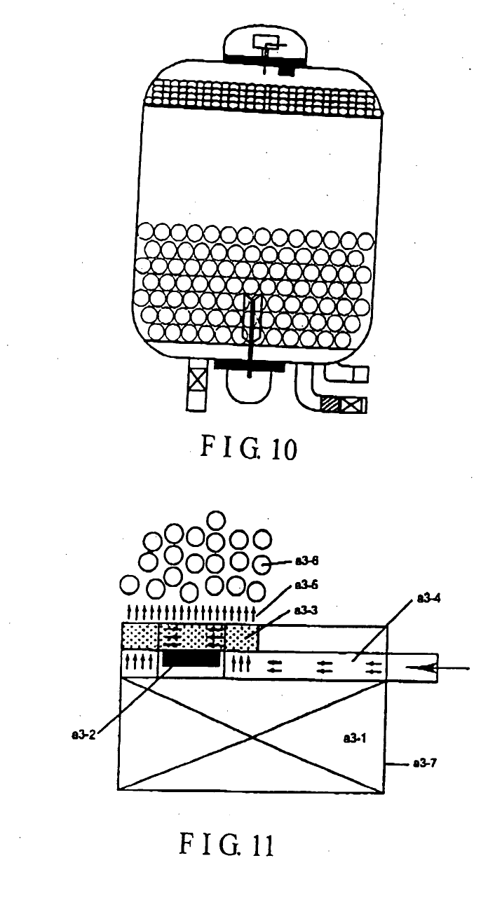

FIG. 6 shows a water purifying process. When the sludge is excessive, the pressure of the receiving barrel a2-1 is increased or a determined time period is reached, the water inlet magnet valve a2-17 is closed to stop supplying the water. At this time, the water outlet magnet valve a2-18 is also closed, and the reverse washing motor a2-15 is started to drive the reverse washing fan a2-14 to proceed a reverse washing process. FIG. 7 shows the reverse washing process. FIG. 8 shows the reverse washing process is completed. FIG. 9 shows the dirty water is being drained outward. At this time, the drain magnet valve a2-19 is opened, and the check valve a2-13 is also opened to drain the dirty water outward. As shown in FIG. 10, the dirty water has been drained outward.

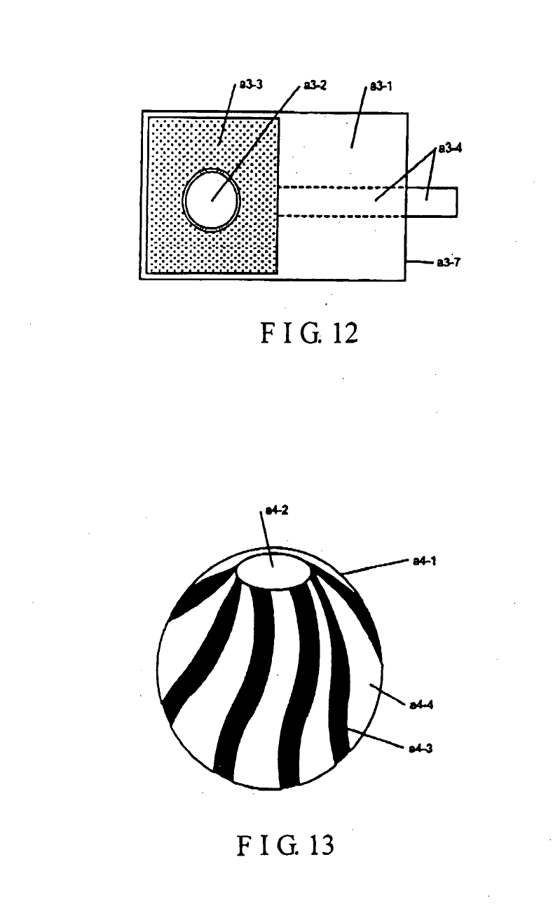

Referring to FIGS. 11 and 12, the atomizer in accordance with the preferred embodiment of the present invention is a supersonic high frequency oscillating atomizer a3-1 and includes a casing a3-7, an oscillating head a3-2, a plurality of bubble-generating stones a3-3, an air guide pipe a3-4, and a gas source a3-5. The bubble-generating stones a3-3 are mounted around the oscillating head a3-2 to connect the air guide pipe a3-4, thereby producing a plurality of bubbles a3-6 around the oscillating head a3-2, so that the water is atomized in the bubbles a3-6 to increase the oxygen content in the water. Thus, the atomizer is mounted on the receiving barrel, with the oscillating head a3-2 being extended into the receiving barrel and connected to a thermal switch so that the atomizer is maintained at a safety temperature of 45 C.

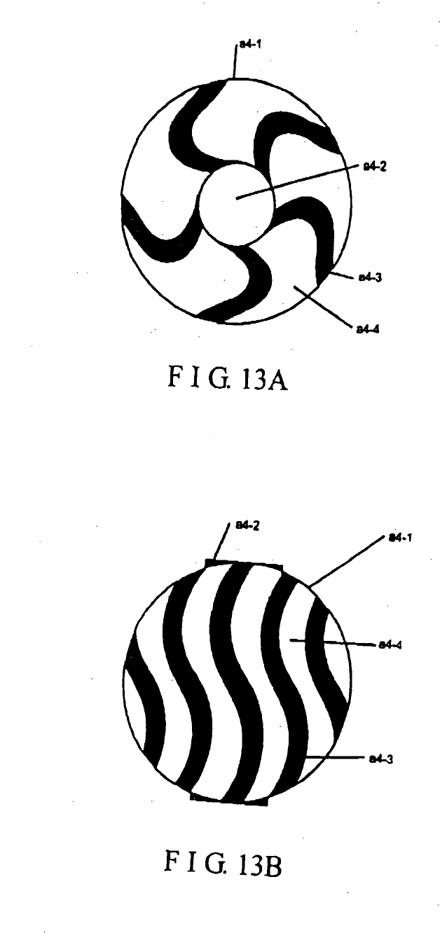

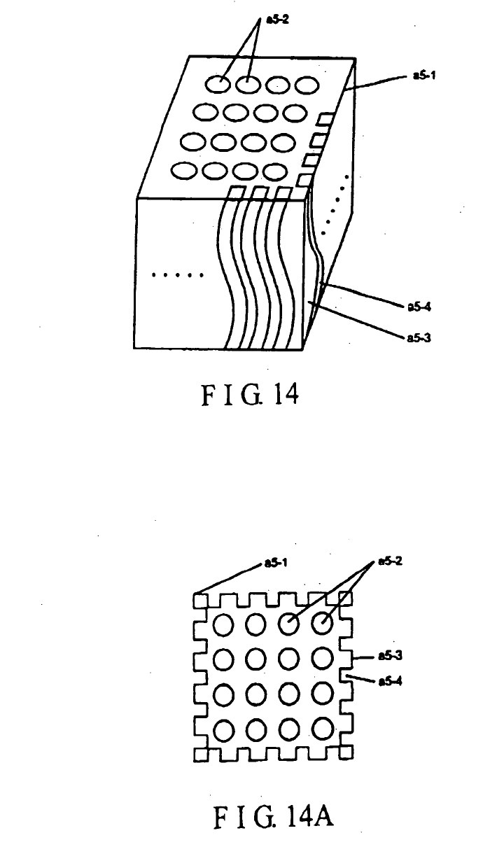

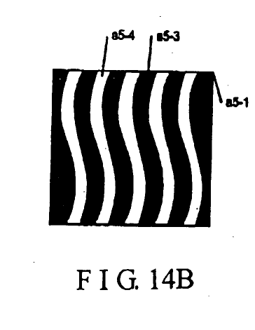

Referring to FIGS. 13 and 14, the magnetized body in accordance with the preferred embodiment of the present invention is a high contact magnetized body and includes a ball a4-1 having a central hole a4-2, a plurality of bent feathers a4-3 and a plurality of bent grooves a4-4. Alternatively, the magnetized body comprises a block a5-1 having a plurality of central holes a5-2, a plurality of bent feathers a5-3 and a plurality of bent grooves a5-4. In fabrication, the ball a4-1 or the block a5-1 is made by mixing plastic powder with special magnet powder. Then, the mixture is pressed in a die, then magnetized and is coated with a dustproof layer to form the ball a4-1 or the block a5-1. When the processed water passes through the magnetized body, the water will flow through the central hole a4-2 and the bent feathers a4-3 of the ball a4-1 or the central hole a5-2 and the bent feathers a5-3 of the block a5-1, and partial of the water will flow through the bent grooves a4-4 of the ball a4-1 or the bent grooves a5-4 of the block a5-1, so as to increase the contact area between the processed water and the magnetized body, thereby enhancing the magnetizing function of the processed water.

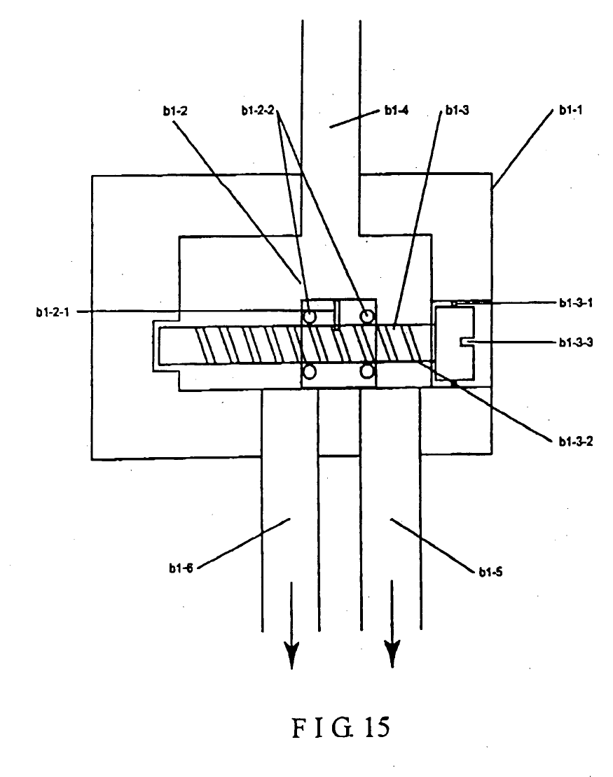

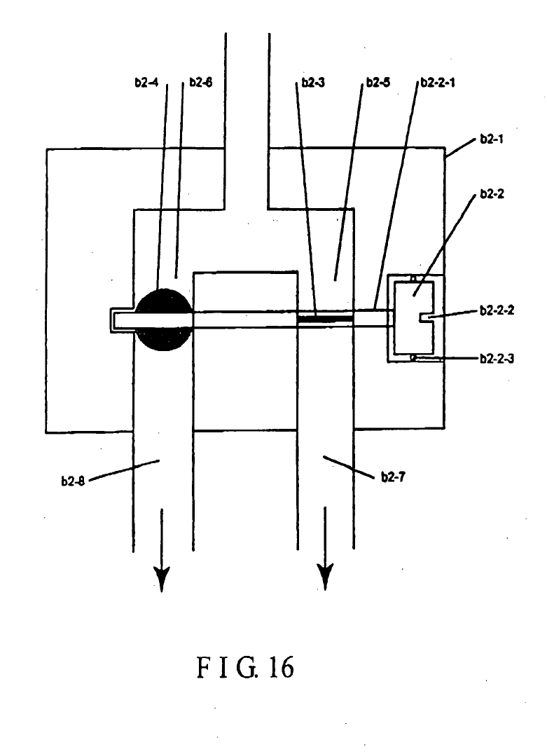

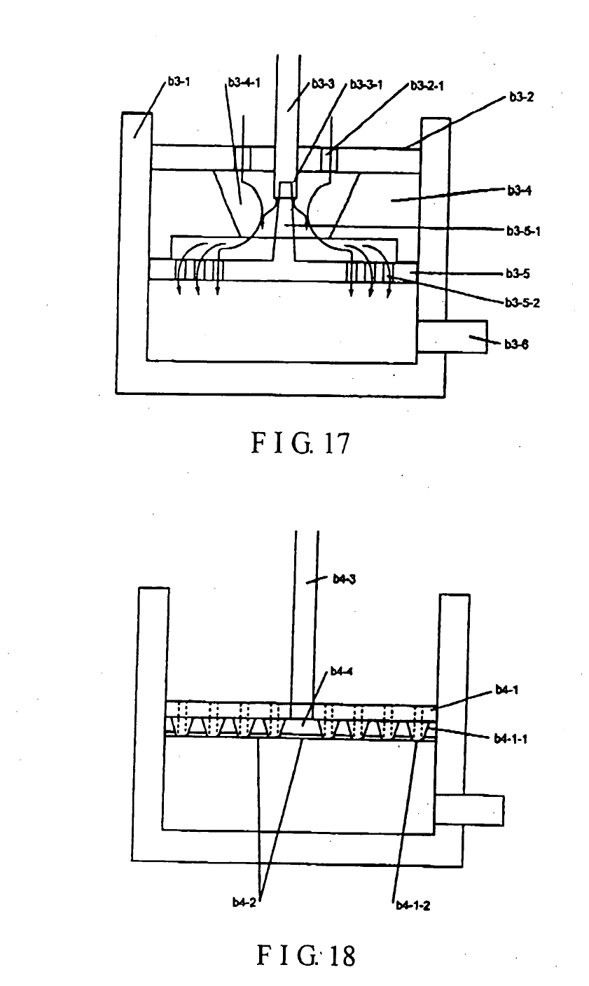

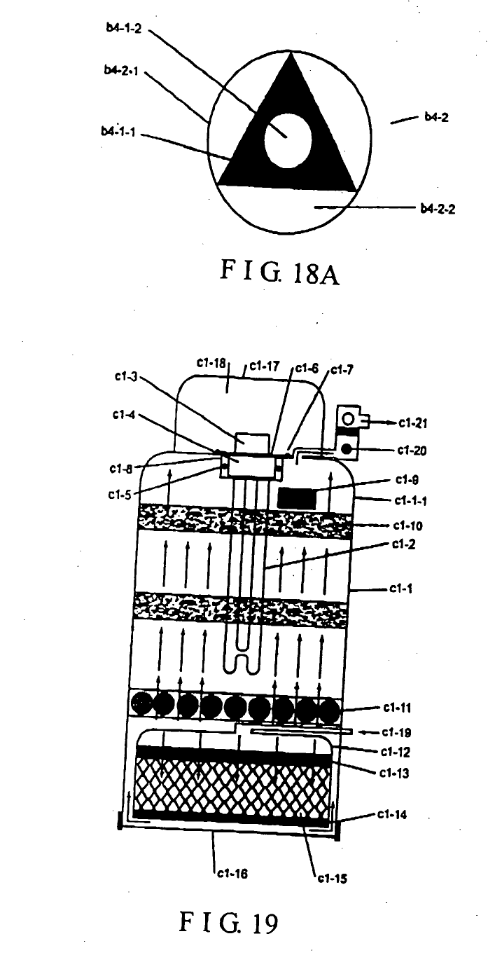

Referring to FIGS. 15-18, the water activating apparatus further comprises a water softening device for controlling the hardness of the water.

The water softening device includes a cursor-plug type water flow regulator b1-1 including a ball screw b1-3 having an urging ring b1-3-1, an outer thread b1-3-2 and a tip groove b1-3-3, a cursor plug b1-2 mounted on the ball screw b1-3 and having a guide mark b1-2-1 and two urging rings b1-2-2, a water inlet b1-4, an extreme softened water pipe b1-5, and an extreme non-softened water pipe b1-6. The guide mark b1-2-1 is inserted into the cursor plug b1-2 and locked in the outer thread b1-3-2 of the ball screw b1-3. When the ball screw b1-3 is rotated, the guide mark b1-2-1 is moved by rotation of the outer thread b1-3-2 of the ball screw b1-3 to move the cursor plug b1-2 to regulate the water flow from the water inlet b1-4 to the extreme softened water pipe b1-5 and the extreme non-softened water pipe b1-6. The urging ring b1-3-1 can prevent the water from leaking from the ball screw b1-3 of the regulator b1-1. The two urging rings b1-2-2 can prevent the extreme softened water pipe b1-5 from connecting to the extreme non-softened water pipe b1-6.

Alternatively, the water softening device includes a dual-piece cross type water flow regulator b2-1 including a regulating rod b2-2 having a shaft b2-2-1, a tip groove b2-2-2 and an urging ring b2-2-3, a softened water regulating plate b2-3, a non-softened water regulating plate b2-4, a softened water inlet b2-5, a non-softened water inlet b2-6, an extreme softened water pipe b2-7, and an extreme non-softened water pipe b2-8. The softened water regulating plate b2-3 is mounted on the shaft b2-2-1 of the regulating rod b2-2 and aligning with the softened water inlet b2-5, and the non-softened water regulating plate b2-4 is mounted on the shaft b2-2-1 of the regulating rod b2-2 and aligning with the non-softened water inlet b2-6. The softened water regulating plate b2-3 intersects the non-softened water regulating plate b2-4 in a dual-piece cross manner, thereby forming the dual-piece cross type water flow regulator b2-1. When the regulating rod b2-2 is rotated, the softened water regulating plate b2-3 and the non-softened water regulating plate b2-4 are rotated to respectively regulate the water flow from the softened water inlet b2-5 and the non-softened water inlet b2-6 to the extreme softened water pipe b2-7 and the extreme non-softened water pipe b2-8.

Accordingly, the cursor-plug type water flow regulator b1-1 or the dual-piece cross type water flow regulator b2-1 is mounted on the water inlet b1-4 of the water softening device to control the water flow flowing into the water pipe of the water softening device.

The water softening device further includes a dual-layer porous type water mixer b3-1 including an upper porous plate b3-2 having a plurality of holes b3-2-1, a non-softened water pipe b3-3 having a non-softened water outlet b3-3-1, a central plate b3-4 having a central hole b3-4-1, a lower porous plate b3-5 having a protruding cone b3-5-1 and a plurality of holes b3-5-2, and a mixing water outlet b3-6. The non-softened water outlet b3-3-1 of the non-softened water pipe b3-3 is extended through the upper porous plate b3-2 and the protruding cone b3-5-1 of the lower porous plate b3-5. The non-softened water flows through the lower porous plate b3-5 into the central hole b3-4-1 of the central plate b3-4 to mix with the softened water from the holes b3-2-1 of the upper porous plate b3-2. Then, the mixed water flows through the gap between the lower porous plate b3-5 and the central plate b3-4 and through the holes b3-5-2 of the lower porous plate b3-5 and then flows outward from the mixing water outlet b3-6.

Alternatively, the water softening device further includes a dual-layer triangular cone type water mixer including an upper plate b4-1 having a protruding triangular cone b4-1-1 having a central hole b4-1-2, a lower plate b4-2 having a circular hole b4-2-1 and a gap b4-2-2 between the circular hole b4-2-1 and the triangular cone b4-1-1, a non-softened water pipe b4-3, and a middle space b4-4 between the upper plate b4-1 and the lower plate b4-2. Thus, the non-softened water is mixed with the softened water evenly.

Accordingly, the dual-layer porous type water mixer b3-1 or the dual-layer triangular cone type water mixer is mounted on the water outlet of the water softening device to evenly mix the softened water and the non-softened water with a determined amount of mineral material, such as magnesium, calcium or the like.

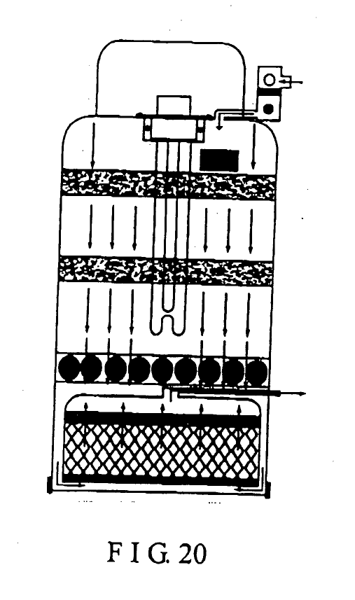

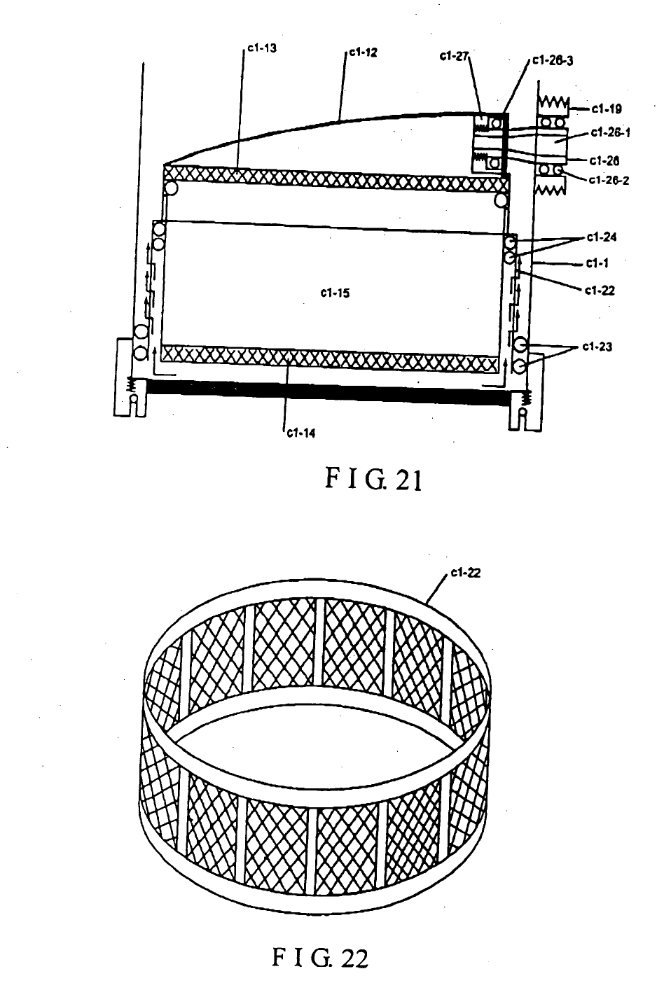

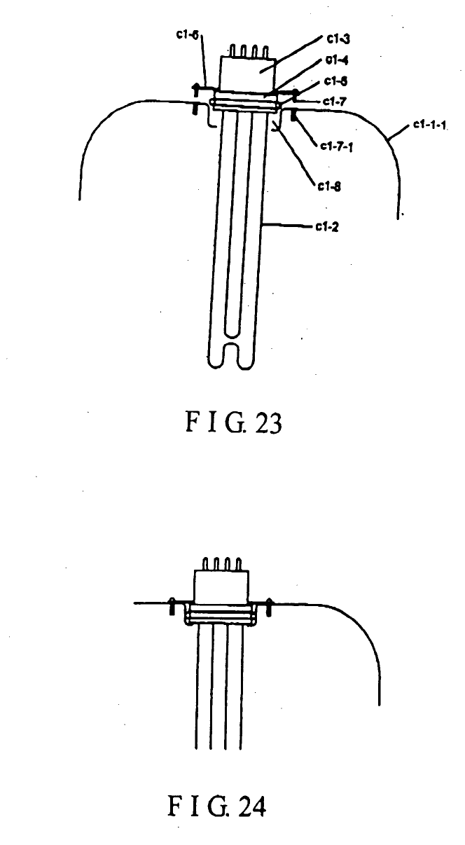

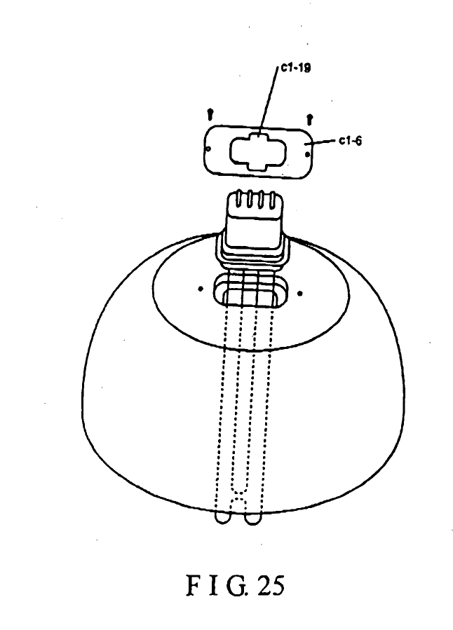

Referring to FIGS. 19-25, the water activating apparatus further comprises an outer barrel (receiving barrel) c1-1 having an upper cover c1-1-1, an ultraviolet sterilizing lamp c1-2, a lamp seat c1-3, an urging seat c1-4 having a fixing plate c1-6, an urging ring c1-5, a screw c1-7, a fixing socket c1-8, a supersonic high frequency oscillating atomizer c1-9, a porous bio-chemical ceramic wave energy plate c1-10, a plurality of high contact magnetized bodies c1-11, an inner barrel c1-12 having a water inlet c1-27, an upper net c1-13 (multi-layer stainless steel filter net having a diameter smaller than 1 μ), a lower net c1-14 (multi-layer stainless steel filter net having a diameter at least 200 mash), a filter barrel c1-15 (containing KDF or AD33S) mounted between the upper net c1-13 and the lower net c1-14, a bottom cover c1-16, a top cover c1-17, a control device c1-18 for controlling the time, temperature and water flow, a water inlet c1-19, a water flow monitor c1-20, a sprayer switch c1-21 having a water outlet, a barrel-shaped filter net c1-22, a lower urging ring c1-23, an upper urging ring c1-24, and a water guide plug c1-26 having a water guide inlet c1-26-1, an outer urging ring c1-26-2 and an inner urging ring c1-26-3.

The ultraviolet sterilizing lamp c1-2 is directly immersed in the water contained in the outer barrel c1-1. The lamp seat c1-3 of the ultraviolet sterilizing lamp c1-2 is provided with an urging seat c1-4 made of transparent plastic material or elastic rubber, and the urging ring c1-5 is urged on the urging seat c1-4. The fixing socket c1-8 is formed in the upper cover c1-1-1 of the outer barrel c1-1 for positioning the urging seat c1-4. The urging seat c1-4 is closely combined with the fixing socket c1-8 by the fixing plate c1-6 of the urging seat c1-4. The fixing plate c1-6 of the urging seat c1-4 is formed with an optical pore to detect the light of the ultraviolet sterilizing lamp c1-2 passes through the transparent urging seat c1-4 so as to monitor operation of the ultraviolet sterilizing lamp c1-2.

The porous bio-chemical ceramic wave energy plate c1-10 is made of a porous bio-chemical ceramic material having a great wave energy. The ceramic material is pressed and heated at high pressure and temperature to form the energy plate c1-10 having pores each having a diameter of at least 20 m/mφ. The ultraviolet sterilizing lamp c1-2 is extended through the energy plate c1-10.

Each of the high contact magnetized bodies c1-11 is the same as that described before.

The supersonic high frequency oscillating atomizer c1-9 is the same as that described before.

The upper net c1-13 and the lower net c1-14 are mounted in the inner barrel c1-12. The upper net c1-13 has a diameter smaller than 1 μ (micron), and the lower net c1-14 has a diameter at least 200 mash so as to remove the pesticide and protect the filter barrel c1-15 containing KDF (removing the heavy metal or chloride) or AD33S (removing the arsenic).

The barrel-shaped filter net c1-22 is mounted between the inner barrel c1-12 and the outer barrel c1-1 and has a diameter smaller than 1 μ (micron). The lower urging ring c1-23 and upper urging ring c1-24 can prevent the water in the inner barrel c1-12 from entering the outer barrel c1-1. The water guide plug c1-26 is mounted between the inner barrel c1-12 and the outer barrel c1-1 and is inserted through the outer barrel c1-1 into the water inlet c1-27 of the inner barrel c1-12 to guide the water from the outer barrel c1-1 through the water guide inlet c1-26-1 into the inner barrel c1-12. The outer urging ring c1-26-2 can prevent the water from leaking outward from the outer barrel c1-1. The inner urging ring c1-26-3 is urged between the water guide plug c1-26 and the water inlet c1-27 of the inner barrel c1-12 to prevent the inner barrel c1-12 from connecting the outer barrel c1-1.

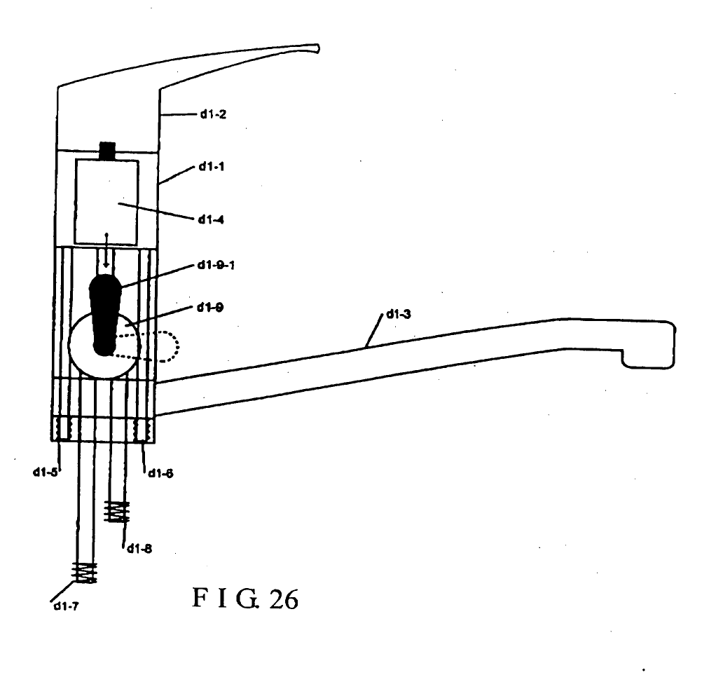

Referring to FIGS. 26-28, the water activating apparatus further comprises a faucet including faucet body d1-1, a handle d1-2, a gooseneck boom d1-3, a water inlet d1-3-1 connected to the gooseneck boom d1-3, a ceramic switch d1-4 (for controlling the water temperature and flow rate), a mixed water port d1-4-1, a hot water inlet d1-5, a cold water inlet d1-6, a mixed water outlet d1-7, a water port d1-7-1 connected to the mixed water outlet d1-7, a mixed water return port d1-8, a water port d1-8-1 connected to the mixed water return port d1-8, and a reverse washing switch d1-9 having a switch handle d1-9-1 and a stopper d1-9-2.

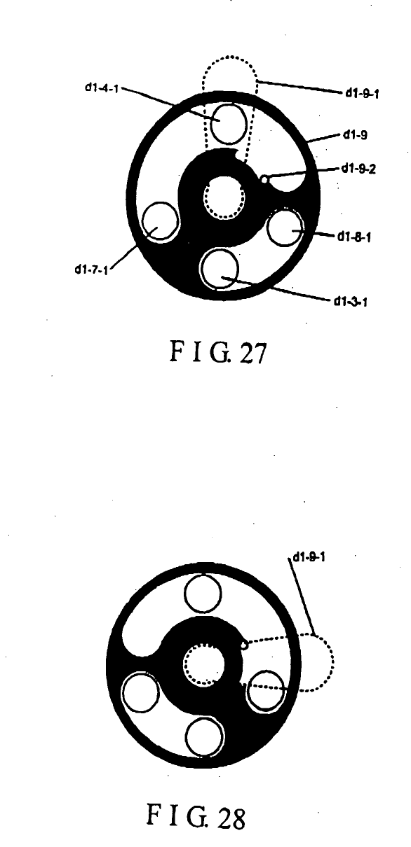

The hot and cold water flows from the hot water inlet d1-5 and the cold water inlet d1-6 into the ceramic switch d1-4 to mix with each other. Then, the mixed water flows through the reverse washing switch d1-9 and flows outward from the mixed water outlet d1-7. Then, the mixed water flows through a water activating machine and flows outward from the outlet of the water activating machine. Then, as shown in FIG. 27, the mixed water flows through the mixed water return port d1-8, the water port d1-8-1, the reverse washing switch d1-9 and the water inlet d1-3-1 into the gooseneck boom d1-3 and then flows outward from the gooseneck boom d1-3. As shown in FIG. 28, the reverse washing switch d1-9 is switched to the reverse washing position, the mixed water flows through the mixed water port d1-4-1 of the ceramic switch d1-4, the water port d1-8-1 and the mixed water return port d1-8, and then flows outward from the mixed water return port d1-8. Then, the mixed water flows through the outlet of the water activating machine and is filtered by the reverse washing filter of the water activating machine and then flows outward from the inlet of the water activating machine. Then, the mixed water flows through the mixed water outlet d1-7, the water port d1-7-1, the reverse washing switch d1-9 and the water inlet d1-3-1 into the gooseneck boom d1-3. Finally, the water after being reverse washed by the reverse washing process flows outward from the gooseneck boom d1-3.

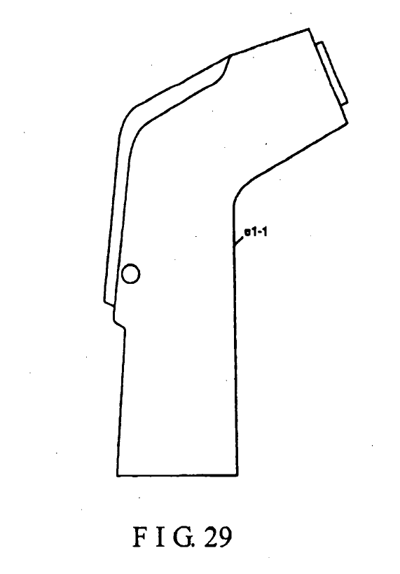

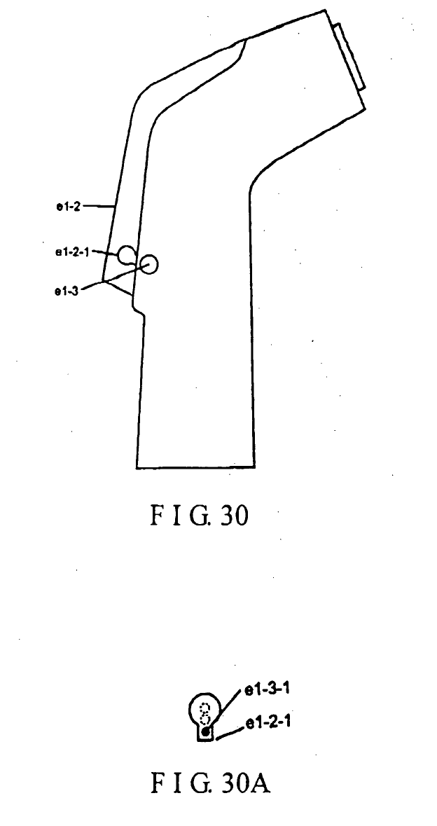

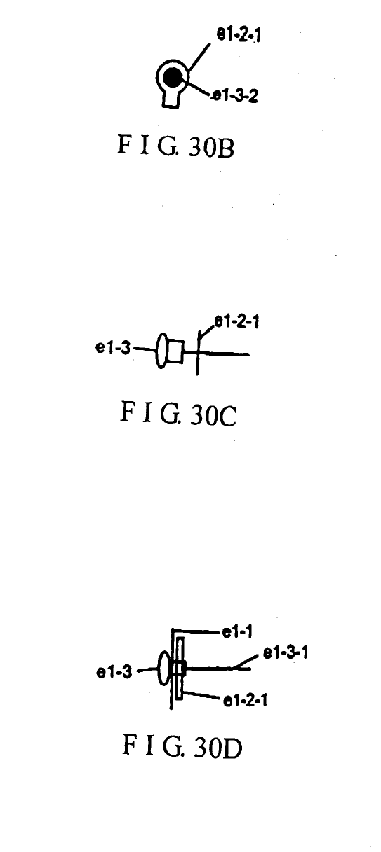

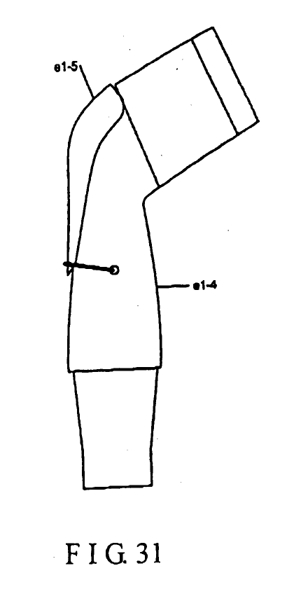

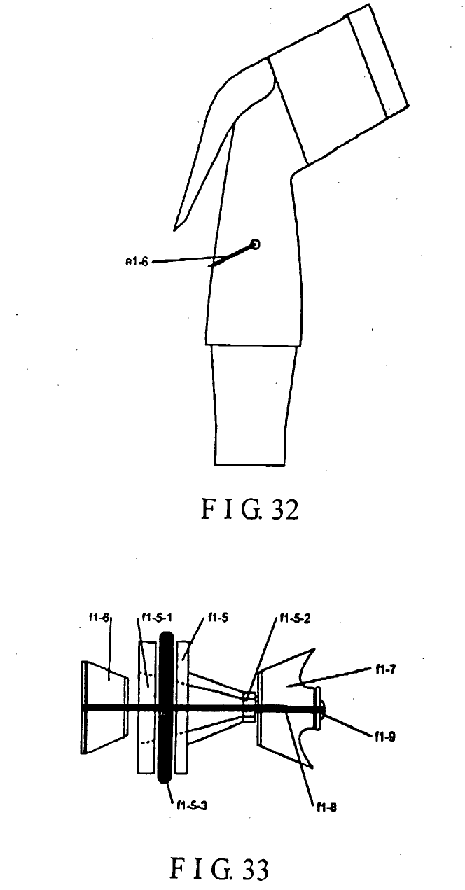

Referring to FIGS. 29-32, the water activating apparatus further comprises a sprayer that can used temporarily or successively. The sprayer includes a first sprayer or a second sprayer. The first sprayer includes a gun body e1-1, a trigger e1-2 having a control hole e1-2-1, and a press button e1-3. FIGS. 30A and 30C show the relative position between the press button e1-3 and the control hole e1-2-1 when the press button e1-3 is not pressed, wherein the trigger e1-2 can be moved freely. FIGS. 30B and 30D show the relative position between the press button e1-3 and the control hole e1-2-1 when the press button e1-3 is pressed, wherein the trigger e1-2 is locked. The second sprayer includes a gun body e1-4, a trigger e1-5, and a control ring e1-6. FIGS. 31 and 32 show the relative position between the trigger e1-5 and the control ring e1-6.

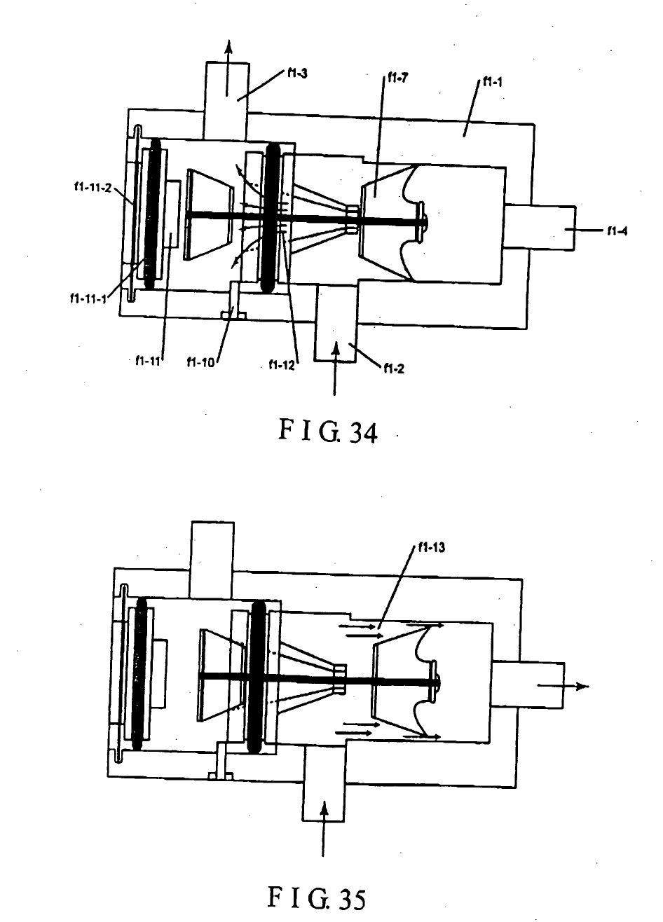

Referring to FIGS. 33-35, the water activating apparatus further comprises a sprayer switch f1-1, a ring f1-5, a movable plug, and a coupler plug f1-11. The sprayer switch f1-1 is mounted between the water activating machine, the faucet and the sprayer. The sprayer switch f1-1 includes a water inlet f1-2, a water outlet f1-3 connected to the faucet, a water outlet f1-4 connected to the sprayer, and a coupler plug f1-11. The ring f1-5 is mounted in the sprayer switch f1-1 and has a hollow portion f1-5-1, a central ring f1-5-2 and an urging ring f1-5-3. The urging ring f1-5-3 is urged on an inner wall of the sprayer switch f1-1. The movable plug is mounted in the sprayer switch f1-1 and includes a central shaft f1-8 extended through the central ring f1-5-2 of the ring f1-5, a first rubber plug head f1-6 mounted on a first end of the central shaft f1-8 and located adjacent to the faucet, a second rubber plug head f1-7 mounted on a second end of the central shaft f1-8 and located adjacent to the sprayer, a retainer f1-9, and a stopper f1-10. The coupler plug f1-11 is mounted in the sprayer switch f1-1 and has an urging ring f1-11-1 and a C-shaped snap ring f1-11-2. When the sprayer is closed, the water pressure pushes the second rubber plug head f1-7 to drive the first rubber plug head f1-6 to detach from the ring f1-5, so that the water flows from the water inlet f1-2 through the hollow portion f1-5-1 of the ring f1-5 into the water outlet f1-3, so that the water is drained outward from the faucet. FIG. 34 shows the streamline f1-12. When the sprayer is opened, the water pressure pushes the first rubber plug head f1-6 to drive the second rubber plug head f1-7, so that the water flows from the water inlet f1-2 through the gap of the second rubber plug head f1-7 into the water outlet f1-4, so that the water is drained outward from the sprayer. FIG. 35 shows the streamline f1-13.

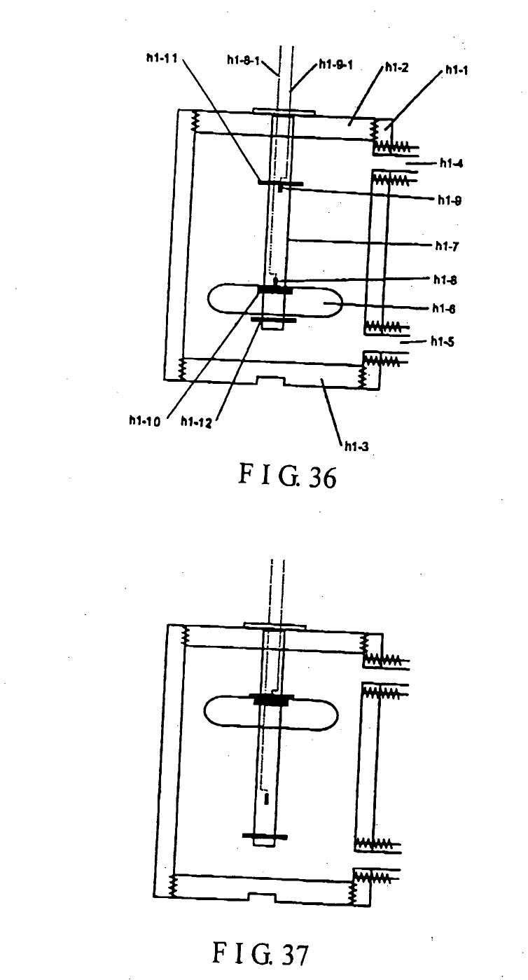

Referring to FIGS. 36 and 37, the water activating apparatus further comprises a water flow monitor h1-1 including an upper end plate h1-2, a lower end plate h1-3, a water inlet h1-4, a water outlet h1-5, a float h1-6, a central pin h1-7, a lower reed switch h1-8 having a connecting line h1-8-1, an upper reed switch h1-9 having a connecting line h1-9-1, an annular magnet h1-10, an upper retainer ring h1-11, and a lower retainer ring h1-12. The float h1-6 is movably mounted on the central pin h1-7 between the upper retainer ring h1-11 and the lower retainer ring h1-12. The annular magnet h1-10 is mounted on the float h1-6 to move therewith. The lower reed switch h1-8 and the upper reed switch h1-9 are mounted on the central pin h1-7 respectively.

As shown in FIG. 37, when the water stops, the float h1-6 is floated by the water contained in the water flow monitor h1-1 and retained on the upper retainer ring h1-11 to open the upper reed switch h1-9 which sends a signal through the connecting line h1-9-1 to a monitoring circuit. At this time, the upper reed switch h1-9 is opened and the lower reed switch h1-8 is connected. When the water flows through the water inlet h1-4 into the water flow monitor h1-1 to push the float h1-6 downward so that the float h1-6 is retained on the lower retainer ring h1-12. At this time, the upper reed switch h1-9 is connected and the lower reed switch h1-8 is opened. When the water stops, the float h1-6 is returned to the original position, so that the upper reed switch h1-9 is opened and the lower reed switch h1-8 is connected. Thus, the water flow monitor h1-1 co-operates with a timer and a thermal switch to form a control device for controlling the time, temperature and water flow, so as to open the ultraviolet sterilizing lamp and the supersonic high frequency oscillating atomizer when the water is flowing, to close the ultraviolet sterilizing lamp and the supersonic high frequency oscillating atomizer when the water flow stops for a predetermined time, and to close the circuit when the temperature exceeds a predetermined value.

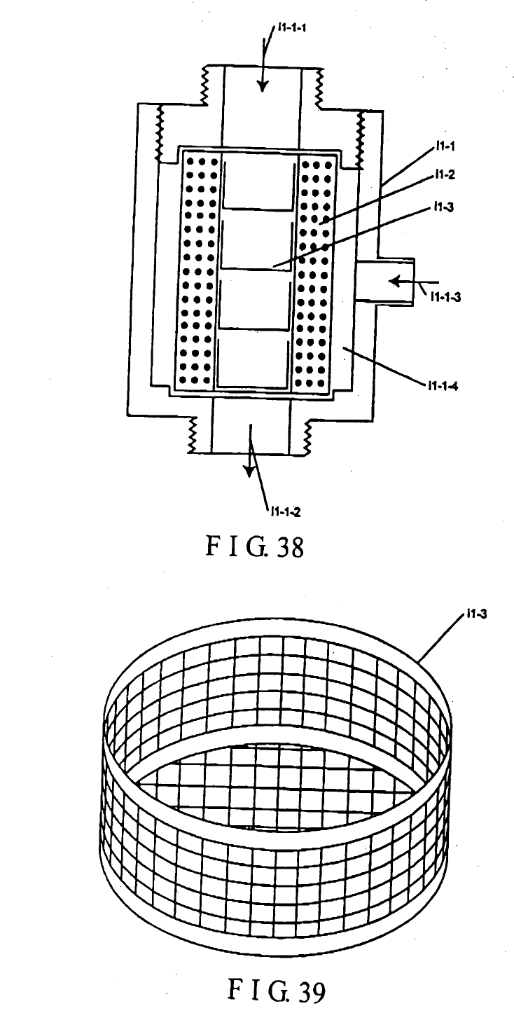

Referring to FIGS. 38 and 39, the water activating apparatus further comprises a gas/water mixer i1-1 including a water inlet i1-1-1, a water outlet i1-1-2, an air inlet i1-1-3, a plurality of bubble generating stones i1-2, a plurality of nets i1-3, and an air cavity i1-4. When the water is flowing, the air flows through the air inlet i1-1-3, the air cavity i1-4, the bubble generating stones i1-2 and the nets i1-3 to mix with the water, thereby mixing the air with the water evenly.

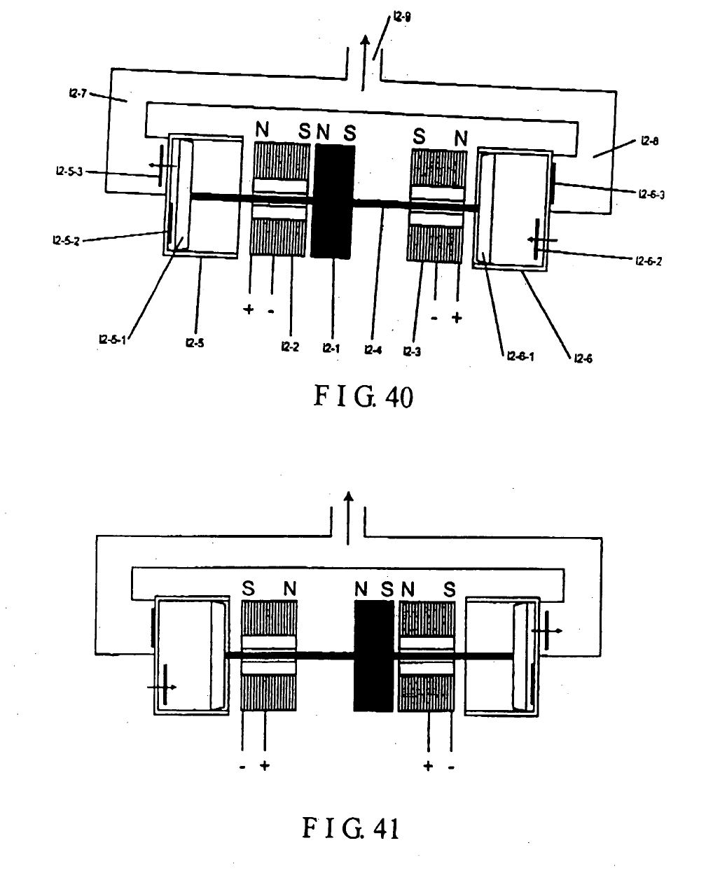

Referring to FIGS. 40 and 41, the water activating apparatus further comprises a magnet-actuating reciprocating high pressure air pump including a permanent magnet i2-1, a first electromagnet i2-2, a second electromagnet i2-3, a central shaft i2-4, a first cylinder i2-5 having a cylinder piston i2-5-1, an intake piston i2-5-2 and an outtake piston i2-5-3, a second cylinder i2-6 having a cylinder piston i2-6-1, an intake piston i2-6-2 and an outtake piston i2-6-3, a first air guide pipe i2-7, a second air guide pipe i2-8, and a common air outlet i2-9. The permanent magnet i2-1, the first electromagnet i2-2 and the second electromagnet i2-3 are connected by the central shaft i2-4. The first cylinder i2-5 and the second cylinder i2-6 are mounted on the two ends of the central shaft i2-4 respectively.

As shown in FIGS. 40 and 41, the poles of the first electromagnet i2-2 and the second electromagnet i2-3 are changed by changing the current direction of the first electromagnet i2-2 and the second electromagnet i2-3 to push the permanent magnet i2-1 to move the central shaft i2-4 which pushes and moves the first cylinder i2-5 and the second cylinder i2-6 reciprocally so as to introduce the air from the first air guide pipe i2-7 and the second air guide pipe i2-8 into the common air outlet i2-9 respectively, thereby obtaining high pressure air.

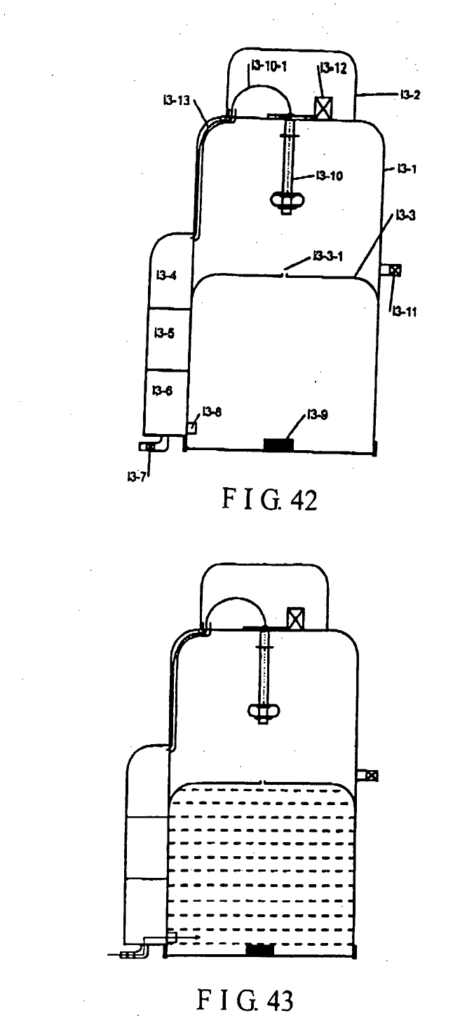

Referring to FIGS. 42-45, the water activating apparatus further comprises a super-oxygen generating barrel i3-1 containing an upper cover i3-2, a separation plate i3-3 having a hole i3-3-1, an air source i3-4, a magnet-actuating reciprocating high pressure air pump i3-5, a gas/water mixer i3-6 having an outlet i3-8, a water inlet and magnet valve i3-7, a supersonic high frequency oscillating atomizer i3-9, a level switch i3-10 having a signal line i3-10-1, a super-oxygen water outlet i3-11, a relief valve i3-12, and a signal line tube i3-13.

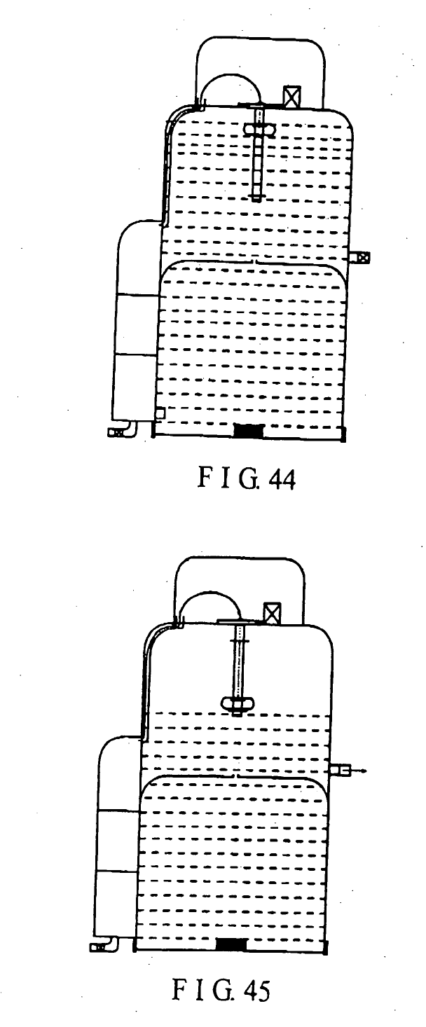

The water inlet and magnet valve i3-7 sends the water into the gas/water mixer i3-6. The gas in the air source i3-4 is pressurized by the magnet-actuating reciprocating high pressure air pump i3-5 and is sent into the gas/water mixer i3-6 to mix with the water. Then, the pressurized gas/water mixture flows through the outlet i3-8 of the gas/water mixer i3-6 into the super-oxygen generating barrel i3-1. Then, the supersonic high frequency oscillating atomizer i3-9 is operated to atomize the pressurized gas/water mixture to increase the oxygen content in the pressurized gas/water mixture. Then, the pressurized gas/water mixture flows through the hole i3-3-1 of the separation plate i3-3 to reach the level switch i3-10 which drives the signal line i3-10-1 to send a signal to the water inlet and magnet valve i3-7 to stop the water flow. At this time, the pressurized gas/water mixture successively flows into the super-oxygen generating barrel i3-1 to increase the oxygen content exceeding 60 pm which is at least one to eight times of the saturated oxygen content of the water. When the pressure in the super-oxygen generating barrel i3-1 exceeds a predetermined value, the relief valve i3-12 releases the air. FIG. 43 shows the water is supplied into the super-oxygen generating barrel i3-1. FIG. 44 shows the water is full of the super-oxygen generating barrel i3-1. FIG. 45 shows the water is drained outward through the super-oxygen water outlet i3-11. When the water level is lowered to reach the level switch i3-10, the signal line i3-10-1 sends a signal to the water inlet and magnet valve i3-7 to supply the water into the super-oxygen generating barrel i3-1.

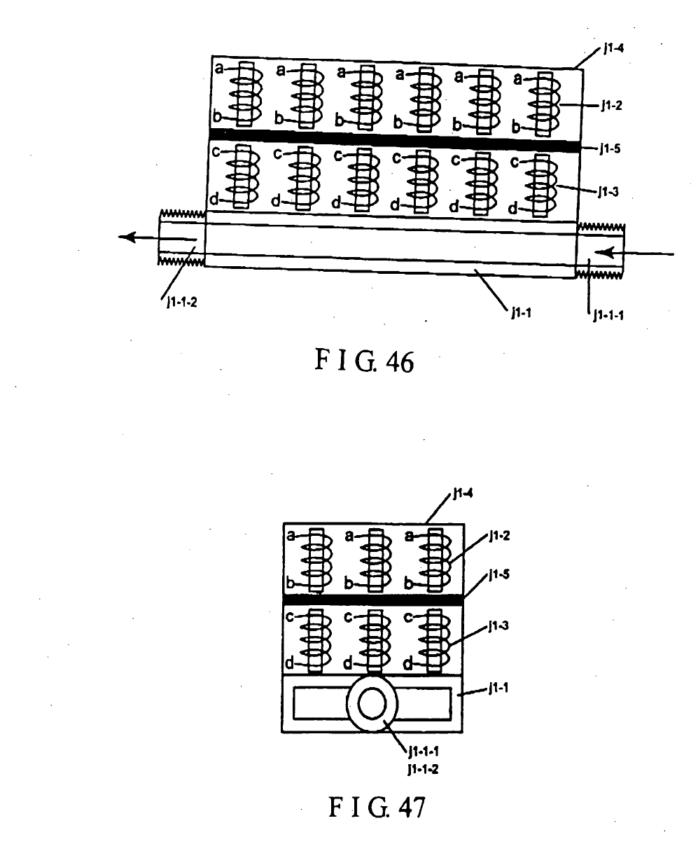

As shown in FIGS. 46 and 47, the water activating apparatus further comprises a transfer device j1-1 including a water inlet j1-1-1, a water outlet j1-1-2, a plurality of upper sensing coils j1-2, a plurality of lower sensing coils j1-3, an upper plate j1-4, and a separation plate j1-5. When the liquid (urine or medicine) to be transferred is placed on the upper plate j1-4, the upper sensing coils j1-2 detect an information signal which is sent by the line a-b to an amplifier. Then, the amplified information signal is sent to the lower sensing coils j1-3 which magnetizes and transfer the amplified information signal into a magnetic wave. Thus, the water from the water inlet j1-1-1 is magnetized successively to obtain a transfer effect, and the magnetized water is drained outward from the water outlet j-1-2. The separation plate j1-5 is mounted between the upper sensing coils j1-2 and the lower sensing coils j1-3 to prevent the information signals of the upper sensing coils j1-2 and the lower sensing coils j1-3 from interfering with each other. Accordingly, the transfer device j1-1 can be used to transfer the bio-chemical wave energy information water successively.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A water activating apparatus, comprising:
(a) a plurality of floatable fibrous filter balls, an atomizer, a plurality of bio-chemical ceramic wave energy tubes, a receiving barrel, and a magnetizer;
(b) a water softening device;
(c) an ultraviolet sterilizing lamp, a porous bio-chemical ceramic wave energy plate, a plurality of magnetized bodies, an multi-layer stainless steel filter net, and a filter barrel;
(d) a faucet;
(e) a sprayer;
(f) a sprayer switch mounted between the faucet and the sprayer;
(g) a reverse washing switch;
(h) a water flow monitor;
(i) a gas/water mixer, a magnet-actuating reciprocating high pressure air pump, and a super-oxygen generating barrel; and
(j) a transfer device.

2. The water activating apparatus in accordance with claim 1, wherein the magnetizer is made of isotropic or anisotropic magnetic material of neodymium-iron-boron alloy, and includes a magnetic inner tube, a magnetic outer tube, a magnetic conducting bar mounted in a center of the inner tube, a magnetic conducting tube mounted on an outer wall the outer tube, and two magnetic conducting end plates each having a water conduit, the magnetic inner tube has an inner wall having a N pole and an outer wall having a S pole, and the magnetic outer tube has an inner wall having a N pole and an outer wall having a S pole or the magnetic inner tube has an inner wall having a S pole and an outer wall having a N pole, and the magnetic outer tube has an inner wall having a S pole and an outer wall having a N pole.

3. The water activating apparatus in accordance with claim 1, wherein each of the floatable fibrous filter balls is made of floating material of polyester, nylon, P.V.C., PP or PE, the floating material is made into a film which has a surface formed with multiple pores by a high frequency corona to have a diameter of at least 1 μ, and is divided into multiple flat lines which are woven into the floatable fibrous filter ball.

4. The water activating apparatus in accordance with claim 1, wherein the atomizer includes an oscillating head, an air guide pipe and a plurality of bubble-generating stones mounted around the oscillating head to connect the air guide pipe.

5. The water activating apparatus in accordance with claim 1, wherein the atomizer is mounted on the receiving barrel, with the oscillating head being extended into the receiving barrel and connected to a thermal switch so that the atomizer is maintained at a safety temperature of 45 C.

6. The water activating apparatus in accordance with claim 1, wherein each of the energy tubes is made of a porous biochemical ceramic material having a great wave energy, the ceramic material is pressed and extruded at high pressure and temperature into a tubular shape to form the energy tube, the energy tubes are connected by a plurality of U-shaped connectors.

7. The water activating apparatus in accordance with claim 1, wherein each of the magnetized bodies is made by mixing plastic powder with special magnet powder to form a mixture which is pressed in a die, is magnetized and is coated with a dustproof layer to form a ball or a block, the ball has a central hole, a plurality of bent feathers and a plurality of bent grooves, and the block has a plurality of central holes, a plurality of bent feathers and a plurality of bent grooves.

8. The water activating apparatus in accordance with claim 1, further comprising a reverse washing fan mounted in the receiving barrel, a reverse washing motor mounted on the receiving barrel and connected to the reverse washing fan to perform a reverse washing process on the floatable fibrous filter balls.

9. The water activating apparatus in accordance with claim 1, further comprising a check valve mounted on the receiving barrel to introduce the air into the receiving barrel when the sludge is drained outward.

10. The water activating apparatus in accordance with claim 1, further comprising a water inlet magnet valve, a water outlet magnet valve, and a drain magnet valve mounted on the receiving barrel respectively.

11. The water activating apparatus in accordance with claim 1, wherein the water softening device includes a cursor-plug type water flow regulator or a dual-piece cross type water flow regulator mounted on a water inlet of the water softening device to control a water flow flowing into a softened water pipe and a non-softened water pipe of the water softening device.

12. The water activating apparatus in accordance with claim 1, wherein the water softening device includes a dual-layer porous type water mixer or a dual-layer triangular cone type water mixer dual-layer triangular cone type water mixer mounted on a water outlet of the water softening device to mix a softened water with a non-softened water.

13. The water activating apparatus in accordance with claim 1, wherein the magnetizer is a dual-tube liquid magnetizer.

14. The water activating apparatus in accordance with claim 1, wherein the ultraviolet sterilizing lamp is directly immersed in water contained in the receiving barrel and has a lamp seat provided with an urging seat made of transparent plastic material or elastic rubber, and an urging ring is urged on the urging seat.

15. The water activating apparatus in accordance with claim 14, wherein the receiving barrel has an upper cover formed with a fixing socket for positioning the urging seat, the urging seat is combined with the fixing socket by a fixing plate of the urging seat.

16. The water activating apparatus in accordance with claim 15, wherein the fixing plate of the urging seat is formed with an optical pore to detect the light of the ultraviolet sterilizing lamp passes through the transparent urging seat so as to monitor operation of the ultraviolet sterilizing lamp.

17. The water activating apparatus in accordance with claim 1, wherein the energy plate is made of a porous bio-chemical ceramic material having a great wave energy, the ceramic material is pressed and heated at high pressure and temperature to form the energy plate having pores each having a diameter of at least 20 m/mφ, and the ultraviolet sterilizing lamp is extended through the energy plate.

18. The water activating apparatus in accordance with claim 1, wherein each of the magnetized bodies is a multi-directional high contact magnetized bodies.

19. The water activating apparatus in accordance with claim 1, wherein the atomizer is a supersonic high frequency oscillating atomizer.

20. The water activating apparatus in accordance with claim 1, further comprising an upper net and a lower net each mounted in an inner barrel of the receiving barrel, the upper net has a diameter smaller than 1 μ (micron), and the lower net has a diameter at least 200 mash.

21. The water activating apparatus in accordance with claim 20, further comprising a barrel-shaped filter net mounted between the inner barrel and the outer barrel and having a diameter smaller than 1 μ (micron).

22. The water activating apparatus in accordance with claim 20, further comprising a filter barrel mounted between the upper net and the lower net.

23. The water activating apparatus in accordance with claim 20, further comprising a water inlet magnet valve and a water outlet magnet valve each mounted on the receiving barrel respectively, and a reverse washing motor mounted on the receiving barrel to perform a reverse washing process on the upper net and the lower net.

24. The water activating apparatus in accordance with claim 1, further comprising a water guide plug mounted between the inner barrel and the receiving barrel to guide water from the receiving barrel into the inner barrel and having a water guide inlet, an outer urging ring and an inner urging ring, wherein the outer urging ring can prevent the water from leaking outward from the outer barrel, the inner urging ring is urged between the water guide plug and an water inlet of the inner barrel to prevent the inner barrel from connecting the outer barrel.

25. The water activating apparatus in accordance with claim 1, wherein the faucet includes faucet body, a handle, a gooseneck boom, a water inlet connected to the gooseneck boom, a ceramic switch, a mixed water port, a hot water inlet, a cold water inlet, a mixed water outlet, a water port connected to the mixed water outlet, a mixed water return port, a water port connected to the mixed water return port, and a reverse washing switch.

26. The water activating apparatus in accordance with claim 1, wherein the sprayer switch has a first water outlet connected to the faucet and a second water outlet connected to the sprayer.

27. The water activating apparatus in accordance with claim 26, further comprising a ring, and a movable plug, wherein the ring is mounted in the sprayer switch and has a hollow portion, a central ring and an urging ring, the urging ring is urged on an inner wall of the sprayer switch, the movable plug is mounted in the sprayer switch and includes a central shaft extended through the central ring of the ring, a first rubber plug head mounted on a first end of the central shaft and located adjacent to the faucet, and a second rubber plug head mounted on a second end of the central shaft and located adjacent to the sprayer.

28. The water activating apparatus in accordance with claim 25, wherein the reverse washing switch has a switch handle and a stopper.

29. The water activating apparatus in accordance with claim 1, wherein the water flow monitor includes an upper end plate, a lower end plate, a water inlet, a water outlet, a float, a central pin, a lower reed switch having a connecting line, an upper reed switch having a connecting line, an annular magnet, an upper retainer ring, and a lower retainer ring, the float is movably mounted on the central pin between the upper retainer ring and the lower retainer ring, the annular magnet is mounted on the float to move therewith, and the lower reed switch and the upper reed switch are mounted on the central pin respectively.

30. The water activating apparatus in accordance with claim 1, wherein the gas/water mixer includes a water inlet, a water outlet, an air inlet, a plurality of bubble generating stones, a plurality of nets, and an air cavity, so that when the water is flowing, the air flows through the air inlet, the air cavity, the bubble generating stones and the nets to mix with the water, thereby mixing the air with the water.

31. The water activating apparatus in accordance with claim 1, wherein the magnet-actuating reciprocating high pressure air pump includes a permanent magnet, a first electromagnet, a second electromagnet, a central shaft, a first cylinder having a cylinder piston, an intake piston and an outtake piston, a second cylinder having a cylinder piston, an intake piston and an outtake piston, a first air guide pipe, a second air guide pipe, and a common air outlet, the permanent magnet, the first electromagnet and the second electromagnet are connected by the central shaft, and the first cylinder and the second cylinder are mounted on the two ends of the central shaft respectively.

32. The water activating apparatus in accordance with claim 1, wherein the super-oxygen generating barrel contains an upper cover, a separation plate having a hole, an air source, a magnet-actuating reciprocating high pressure air pump, a gas/water mixer having an outlet, a water inlet and magnet valve, a supersonic high frequency oscillating atomizer, a level switch having a signal line, a super-oxygen water outlet, a relief valve, and a signal line tube.

33. The water activating apparatus in accordance with claim 1, wherein the transfer device includes a water inlet, a water outlet, a plurality of upper sensing coils, a plurality of lower sensing coils, an upper plate, and a separation plate, the separation plate is mounted between the upper sensing coils and the lower sensing coils to prevent information signals of the upper sensing coils and the lower sensing coils from interfering with each other.
